(19) United States
(12) Patent Application Publication
(10) Pub. No.: US 2025/0130096 A1
(43) Pub. Date: Apr. 24, 2025

(54) Bidirectional Optical Communication Fiber Sensing Control Device

(71) Applicant: Nokia Solutions and Networks Oy, Espoo (FI)

(72) Inventor: Mijail Szczerban Gonzalez, Murray Hill, NJ (US)

(73) Assignee: Nokia Solutions and Networks Oy, Espoo (FI)

(21) Appl. No.: 18/582,629

(22) Filed: Feb. 20, 2024

Related U.S. Application Data
(60) Provisional application No. 63/592,341, filed on Oct. 23, 2023.

(51) Int. Cl. G01H 9/00; G01D 5/353; H04B 10/071; H04B 10/25

(52) U.S. Cl. CPC G01H 9/004; G01D 5/35358; H04B 10/2589; H04B 10/071

(57) ABSTRACT

Control of fiber sensing is provided for optical fiber networks. A Bidirectional Sensing Control Devices (BSCD) is placed at each of one or more selected locations in the network. The BSCD uses a directionally selective optical coupling element to separate the two propagation directions of a bidirectional fiber, so that on the side of the coupling element distal to the bidirectional fiber, one unidirectional fiber will carry transmissions inbound to the coupling element, and another unidirectional fiber will carry transmissions outbound from the coupling element. Sensing control can then be effectuated on one or both of the unidirectional fibers without interrupting communication in either propagation transmission direction.

### CROSS REFERENCE TO RELATED APPLICATIONS

This application claims the benefit of Provisional Application Ser. No. 63/592,341, filed in the US Patent and Trademark Office on Oct. 23, 2023.

This application contains subject matter related to the subject matter of patent application Ser. No. 18/241,933, filed in the U.S. Patent and Trademark Office on Sep. 4, 2023.

### TECHNICAL FIELD

The present disclosure relates to fiber sensing in optical fiber networks, and more particularly to systems and methods for controlling fiber sensing in such networks.

### ART BACKGROUND

There are several fiber-sensing methods that can extract details of the fiber infrastructure when they are applied to an optical fiber network. These methods may exploit, e.g., backscattering phenomena or changes in state of polarization (SoP) to obtain information. For example, optical time-domain reflectometry (OTDR) is widely used for network diagnostics. Distributed acoustic sensing (DAS) and SoP measurements are also being used to extract information from the fiber infrastructure through in-band and out-of-band channels.

The information that these and similar tools can obtain may include the distribution of networking elements such as splitters, connectors, endpoints, and splices, estimates of span lengths, details on the number of users connected to the network, and sensing of mechanical vibrations in certain points of the fibers due to acoustic pickup of human speech, among other things. These tools can be very useful in the hands of an authorized user such as a network owner or network operator, but they can pose a security risk if unauthorized users have access. Fiber-sensing control, i.e., control over when and where fiber sensing is performed, may be valuable for protecting against unauthorized sensing, for protecting privacy in specific areas during specified periods, and for enhancing authorized sensing by, e.g., limiting an authorized troubleshooting measurement or the like to selected regions of the network.

Some optical fiber networks are configured for bidirectional optical communication, i.e., for communication in which a single fiber is used to carry transmissions in both of the possible propagation directions along the fiber. Other optical fiber networks are configured for unidirectional optical communication, in which only a single propagation direction is used on a given fiber. Passive optical network (PON) systems provide an example of networks using bidirectional optical communication. In a PON network, among other typical optical access networks, downlink and uplink optical signals can be sent through the same optical fiber.

Hence, there is a need for new approaches to fiber-sensing control that are more suitable for bidirectional systems.

### SUMMARY OF THE DISCLOSURE

Some systems for fiber-sensing control that have been proposed for unidirectional systems would be less desirable in PON environments or other bidirectional systems because operation of such unidirectional fiber transmission sensing control systems would interrupt data transmission on one propagation direction of the bidirectional fiber when controlling backscattering-based sensing on the other propagation direction of the same fiber.

Disclosed here is a new approach in which fiber-sensing control is implemented using one or more Bidirectional Sensing Control Devices (BSCDs) placed at each of one or more selected locations in an optical fiber network. The BSCD uses a directionally selective optical coupling element to separate the two propagation directions of a bidirectional fiber, so that on the side of the coupling element distal to the bidirectional fiber, one unidirectional fiber will carry transmissions inbound to the coupling element, and another unidirectional fiber will carry transmissions outbound from the coupling element. Sensing control can then be effectuated on one or both of the unidirectional fibers without interrupting communication in cither propagation transmission direction.

The functionality of such a directionally selective optical element may be implemented, for example, by an optical circulator. Another example of a directionally selective optical element, among others, is a wavelength filter/splitter, which could be used to separate one communication direction from the other in cases where each propagation direction uses a different wavelength band.

With suppression or gating of backscattered light, the backscattered light can be prevented from returning to a sensing source, e.g., an unauthorized sensing source, located outside a network infrastructure designated for protection by the BSCD. In that way, protection can be provided against unauthorized sensing by backscattering-based fiber-sensing techniques such as OTDR and DAS.

With suitable control, the owner or operator of a network infrastructure could be enabled to control when and where fiber-monitoring and fiber-sensing activities take place. Such an ability may be useful, e.g., for preventing unauthorized collection of details of network infrastructure. It may also be useful, e.g., for enhancing the authorized sensing of a network.

In an illustrative example of such enhancement, the authorized sensing system probes a PON network from the input side of a splitter from which many fibers diverge at the output side. Because backscattered light could potentially be retrieved from many fibers, it could be challenging to distinguish which of the fibers is the origin of a specific event of interest. With suitable control, however, sensing could be performed in only one, or in only a few, fibers, while the interference from the other fibers could be reduced.

The placement of BSCDs could create physical boundaries that define protected infrastructure regions and limit the reach of backscattering-based sensing of the protected regions. Each BSCD would preferably be situated within secured premises that are accessible only by authorized personnel.

A BSCD may be reconfigurable or non-reconfigurable. A non-reconfigurable BSCD, once installed, would disable fiber sensing in its protected region. To enable fiber-sensing from external devices, the non-reconfigurable BSCD would have to be removed or bypassed. By contrast, a reconfigurable BSCD would enable fiber-sensing in response to a suitable control signal, which could, e.g., be conditional on successful authentication.

In embodiments, the approach disclosed here could potentially support diversified optical network services including, for example, services for customers that would pay for the sensing features standing alone or combined with communication features. In embodiments, the approach disclosed here could also potentially allow an infrastructure owner that leases fibers or wavelengths on a network to selectively enable sensing for trusted customers in compliance, e.g., with established security standards.

Accordingly, the present disclosure relates in a first aspect to a system comprising at least a first network segment and at least a first bidirectional sensing control device (BSCD) situated at a first boundary of the first network segment. The first network segment comprises a network infrastructure, within which a pair of oppositely directed unidirectional optical fibers carry optical transmissions. The first BSCD comprises a directionally selective optical coupling circuit configured as an interface between a first bidirectional optical fiber cable segment and the fiber pair. The coupling circuit is configured such that each fiber of the fiber pair is coupled to the first fiber cable segment for optical propagation in a respective propagation direction. Further, the coupling circuit is configured to block counterpropagating light from returning from the network infrastructure to the first cable segment.

In embodiments, the directionally selective optical coupling circuit comprises an optical circulator configured to couple downstream light from the first bidirectional fiber cable segment into one of the unidirectional fibers, and to couple upstream light from the other of the unidirectional fibers into the first cable segment. In more specific embodiments, the directionally selective optical coupling circuit further comprises an optical isolator configured to block counterpropagating light from returning from the network infrastructure to the first fiber cable segment.

In embodiments, one of the unidirectional fibers is a downstream fiber for light propagating from the first fiber cable segment to the network infrastructure, the first BSCD further comprises a bypass path for counterpropagating light going from the downstream fiber to the first fiber cable segment; and the bypass path includes an optical gate to controllably allow and disallow entry of the counterpropagating light to the first fiber cable segment.

In some more specific embodiments the first BSCD further comprises a control circuit configured for activating and deactivating the optical gate.

In some more specific embodiments, the control circuit is configured to detect a command signal transmitted on the first fiber cable segment, and to respond to the command signal by activating the optical gate to open or close.

In some more specific embodiments, the control circuit is configured to detect a signal pattern transmitted on the first fiber cable segment that is indicative of an intrusion attempt, and to respond to the detected pattern by activating the optical gate to close.

In embodiments, the system comprises two or more BSCDs, each of which is situated at a boundary of the first network segment. Each of the two or more BSCDs comprises a directionally selective optical coupling circuit configured as an interface between a respective bidirectional optical fiber cable segment and a respective pair of unidirectional optical fibers, such that each fiber of the respective fiber pair is coupled to the respective bidirectional optical fiber cable segment for optical propagation in a respective propagation direction. The directionally selective optical coupling circuit of each of the two or more BSCDs is configured with an optical gate to controllably block counterpropagating light from returning from the network infrastructure to the respective cable segment connected to the BSCD. Each of the two or more BSCDs further comprises a control circuit for causing the optical gate to open or close.

In more specific embodiments, the system further comprises a sensing region controller configured to enable and disable sensing within the first network segment by sending instructions to the control circuit of each of the two or more BSCDs in the first network segment.

In still more specific embodiments, the system comprises two or more network segments, wherein at least one BSCD is situated at a boundary of each of the two or more network segments, and a respective sensing region controller for each of the two or more network segments is configured to enable and disable sensing within its own network segment by sending instructions to the control circuit of each of the two or more BSCDs within its own network segment. Furthermore, the system may further comprise a central sensing manager configured to orchestrate sensing control across the two or more network segments by sending instructions to the respective sensing controller of each of the two or more network segments.

In a second aspect, the present disclosure relates to a method for controlling fiber sensing in a network segment that includes a network infrastructure that sends and receives transmissions on a bidirectional optical fiber cable segment. The method comprises an operation, at a boundary of the network segment, of coupling optical transmissions between the bidirectional optical fiber cable segment and a pair of oppositely directed unidirectional optical fibers that carry optical transmissions within the network infrastructure. The coupling is performed such that each fiber of the fiber pair is coupled to the first fiber cable segment for optical propagation in a respective propagation direction, and such that counterpropagating light is blocked from returning from the network infrastructure to the first fiber cable segment.

In embodiments, the method further comprises controllably opening and closing an optical bypass path that, when open, allows counterpropagating light to return from the network infrastructure to the first fiber cable segment.

In some more specific embodiments, the controllably opening and closing an optical bypass path is performed in response to a command signal transmitted from a control unit.

In some more specific embodiments, the controllably opening and closing an optical bypass path is performed in response to detecting an anomalous signal pattern transmitted on the bidirectional optical fiber cable segment.

In some more specific embodiments, the controllably opening and closing an optical bypass path is performed in response to detecting a prespecified signal pattern transmitted from an authorized fiber sensing device on the bidirectional optical fiber cable segment.

### BRIEF DESCRIPTION OF THE DRAWINGS

FIG. 1 is a cartoon drawing illustrating an example placement of a bidirectional sensing control device (BSCD) in a bidirectional PON network.

FIG. 2 is a schematic drawing showing, within a network, an example of a non-reconfigurable BSCD that has separate receiver and transmitter fiber ports.

FIG. 3 is a schematic drawing showing, within a network, an example of a reconfigurable BSCD that has separate receiver and transmitter fiber ports. As an aid to understanding, arrows have been added to indicate the light paths taken, respectively, by downstream and upstream transmissions. By “downstream” is meant the direction from the network toward customer premises; by “upstream” is meant the direction from customer premises toward the network.

FIG. 4 is a schematic drawing showing, within a network, an example of a reconfigurable BSCD that has a single transceiver port within a protected premises.

FIG. 5 is a schematic drawing showing, within a network, an example of a reconfigurable BSCD that has a single transceiver port within a protected premises.

FIG. 6 schematically illustrates an example scenario in which three bidirectional fiber cables converge on an infrastructure protected by a system of three respective BSCDs.

FIG. 7 is a schematic drawing showing, within a network, an example of premises protected, at each of two edges, by a non-reconfigurable BSCD that has a single transceiver port.

FIG. 8 is a schematic drawing showing, within a bidirectional fiber network, an example of non-reconfigurable BSCD units placed at the edges of an infrastructure to protect the infrastructure.

FIG. 9 is a schematic drawing showing, within a network region protected by a BSCD, an example of a delay equalization device to account for propagation difference between fibers.

FIG. 10 is a schematic drawing showing an example of a fiber sensing network with BSCDs as demarcation points creating fiber-sensing control regions.

FIG. 11 is a flowchart illustrating BSCD operation in example embodiments. Many of the figures have figure elements in common. Corresponding figure elements may be designated by like reference numerals.

### DETAILED DESCRIPTION

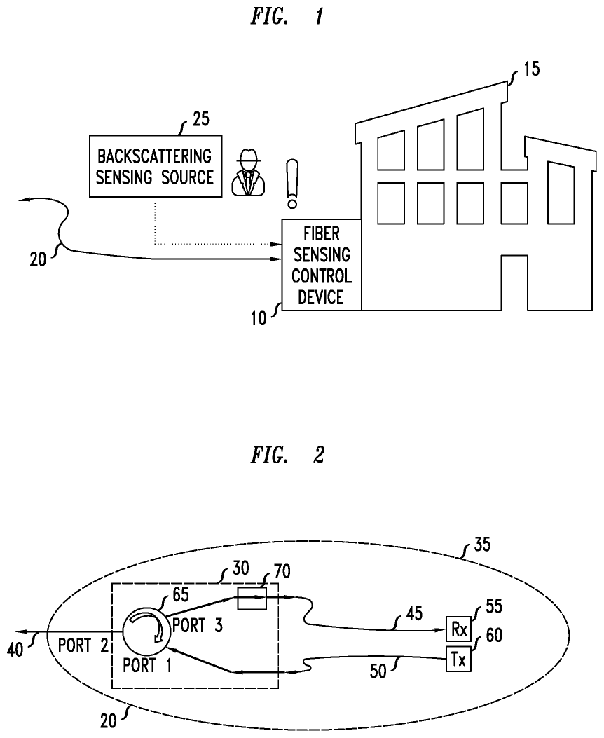

FIG. 1 is a cartoon drawing illustrating an example placement of a bidirectional sensing control device (BSCD) in a bidirectional PON network. As shown in the drawing, a BSCD 10 is placed at an edge of a premises 15 that is to be protected. A bidirectional fiber of the PON network 20 is shown interfacing with the BSCD. An unauthorized backscattering sensing source 25 is shown attempting to traverse the BSCD so that it can gain access to probe the protected premises 15. Several example implementations of a BSCD are described below.

It should be understood that the example implementations provided here are illustrative only, and that they are not meant to be limiting.

In the following discussion, optical propagation directions are defined as follows: The downstream direction is the propagation direction from the network toward customer premises. The upstream direction is the propagation direction from customer premises toward the network. The forward propagation direction is the direction of communication transmissions in a unidirectional fiber. The counterpropagation direction is the direction opposite to the forward propagation direction in a unidirectional fiber. It is the propagation direction of backscattered signals in the unidirectional fiber.

Example 1, non-reconfigurable endpoint protection. FIG. 2 is a schematic drawing showing, within a network, an example of a non-reconfigurable BSCD 30 protecting an infrastructure 35 located at one endpoint of a bidirectional fiber 40, as is typical in, e.g., current PON access systems. The placement of the BSCD defines the network region that is to be protected. The BSCD has separate receiver and transmitter fiber ports, respectively labeled as Port 3 and Port 1 in FIG. 2. Downstream of the BSCD, the fiber cable is divided into a fiber pair, comprising a downstream-directed unidirectional fiber 45 and an upstream-directed unidirectional fiber 50.

The receiver port of the BSCD couples to a receiver 55 at, e.g., user premises via the downstream unidirectional fiber. The transmitter port couples to a transmitter 60 at, e.g., the user premises via the upstream unidirectional fiber. The BSCD separates the two propagation directions of the bidirectional fiber, by using, e.g., an optical circulator 65.

The circulator shown in the figure may be a full circulator or a quasi-circulator, also sometimes referred to as a “two-way” circulator. The circulator has three ports, including Port 1 and Port 3, mentioned above. Beginning with the port that interfaces with the bidirectional fiber and proceeding clockwise, we denominate the respective ports as Port 2, Port 3, and Port 1. If the circulator is a full circulator, a signal entering at any of the three ports is directed clockwise to the next port, where it appears as an output signal. If the circulator is a quasi-circulator, a signal entering at Port 1 or at Port 2 is directed clockwise to the next port, but a signal entering at Port 3 is isolated from the other ports.

Accordingly, Port 2 interfaces with the bidirectional fiber, Port 3, which is next in the clockwise direction, couples to a receiver port of the BSCD, and Port 1, which is next after that in the clockwise direction, couples to a transmitter port of the BSCD. The BSCD receiver port couples to a receiver at, e.g., user premises via the downstream unidirectional fiber. The BSCD transmitter port couples to a transmitter at, e.g., the user premises via the upstream unidirectional fiber.

Backscattered light that counterpropagates on the downstream fiber and returns toward the circulator can be blocked and prevented from reaching a fiber-sensing source located outside of the protected infrastructure. The circulator alone may be sufficient to block the backscattered light if it provides enough isolation between Port 2 and Port 3, as may be the case if the circulator is a quasi-circulator. In that case, the backscattered light would be effectively extinguished upon reaching the circulator. Otherwise, an optical isolator 70 can be added in the downstream-propagating channel within the BSCD, as shown in FIG. 2, to block the backscattering light.

Upstream transmissions from the transmitter propagate in the forward-propagating direction on the upstream unidirectional fiber, enter the circulator, and couple into the bidirectional cable without impediment.

The embodiment of FIG. 2 is non-reconfigurable, because the BSCD represented there cannot be switched between on and off states. Consequently, once the BSCD has been installed, both authorized and unauthorized fiber sensing will be disabled in the protected region. To enable sensing from external devices, the BSCD would have to be bypassed, removed, or deactivated.

In a design variation, not shown in FIG. 2, the upstream and downstream unidirectional optical fibers may converge at respective ports of a second optical circulator. Via a third port, the second circulator interfaces the upstream and downstream fibers with a bidirectional fiber that interfaces with a transceiver having a single, bidirectional port, in place of the separate transmitter and receiver shown in FIG. 2.

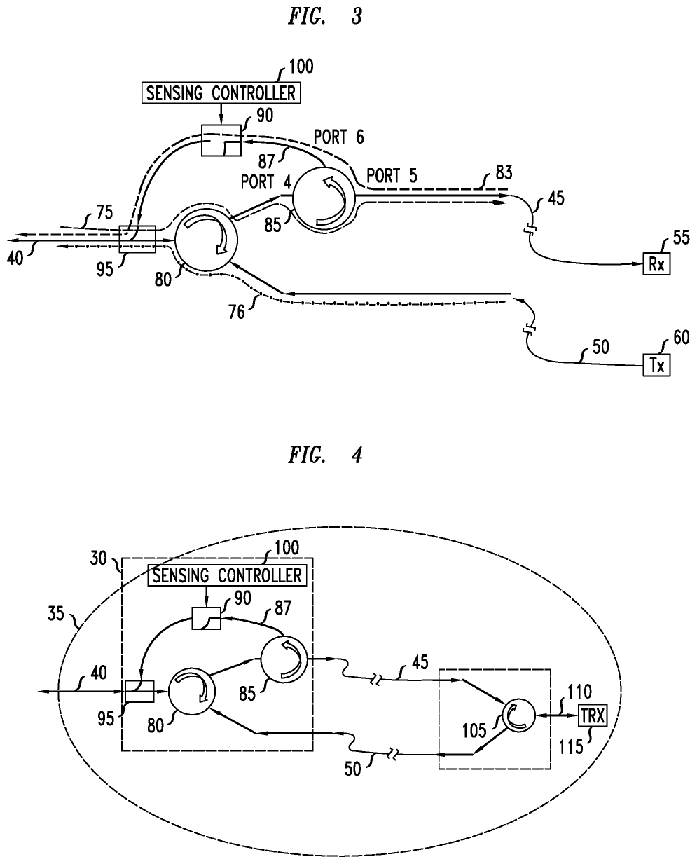

Example 2, reconfigurable endpoint protection, two ports. FIG. 3 is a schematic drawing showing, within a network, an example of a reconfigurable BSCD that has separate receiver and transmitter fiber ports. The embodiment of FIG. 3 operates according to principles similar to those of the embodiment of FIG. 2, but it has the additional capability to enable and disable the fiber sensing on command. As an aid to understanding, arrows have been added to indicate the light paths 75, 76 taken, respectively, by downstream and upstream transmissions.

As shown, the embodiment of FIG. 3 has two circulators, namely, a first circulator 80 corresponding to the circulator 65 shown in FIG. 2, and a second circulator 85 that is added to Port 3 of the first circulator, such that light exiting forward-propagating Port 3 of the first circulator enters the second circulator at a port here designated as Port 4 and exits the second circulator at the next port counterclockwise, which is here designated as Port 5. The light that exits Port 5 propagates in the forward-propagating direction toward the receiver 55 on the downstream-directed unidirectional fiber 45 shown in the figure.

Backscattered light 83 approaching the second circulator 85 from the forward-propagating unidirectional fiber enters the second circulator at Port 5, and it is directed to the next port counterclockwise, which is here denominated as Port 6. Light exiting Port 6 propagates through a return path 87 that passes through an optical gate 90 and then couples into the bidirectional fiber 40 by way of, for example, an optical power combiner 95. Controlling the optical gate from, e.g., sensing controller 100, gives permissive control over fiber sensing performed from the external bidirectional fiber into the protected fiber infrastructure. When the optical gate is open, the backscattered light will be sent back to the bidirectional external fiber. When the optical gate is closed, backscattered light will be blocked from reaching the external bidirectional fiber.

As in the embodiment of FIG. 2, upstream transmissions from the transmitter propagate in the forward-propagating direction on the upstream unidirectional fiber, enter the first circulator, and couple into the bidirectional cable without impediment.

In a design variation shown in FIG. 4, the upstream and downstream unidirectional optical fibers may converge at respective ports of a third optical circulator 105. Via a third port, the third circulator interfaces the upstream fiber 50 and downstream fiber 45 with a bidirectional fiber 110 that interfaces with a transceiver 115 having a single, bidirectional port, in place of the separate transmitter and receiver shown in FIG. 3.

Example 3, reconfigurable fiber segment protection. FIG. 5 is a schematic drawing showing, within a network, an example of a reconfigurable BSCD system that has a single transceiver port within a protected premises 35. In the example of FIG. 5, the BSCD system comprises two separate BSCDs 30, 120.

In some instances, the placement of a BSCD is at a fiber infrastructure endpoint, such as an optical network unit (ONU) in a PON system. In the embodiment of FIG. 5, by contrast, the BSCDs are placed for protection of an infrastructure traversed by the bidirectional fiber. For example, BSCDs may be placed at the edges of the infrastructure to be protected, where, e.g., they control the availability of fiber sensing in the fiber segment located within the protected infrastructure.

As shown in FIG. 5, the network region 35 to be protected is defined by placing first BSCD 30 and second BSCD 120 at respective edges of a network infrastructure. Each of the BSCDs includes a first circulator, respectively 80 and 80′, a second circulator, respectively 85 and 85′, a controllable optical gate, respectively 90 and 90′, and a power combiner, respectively 95 and 95′. In each of the BSCSs 30, 120, the circulators, the optical gate, and the power combiner cooperate in the manner described above in reference to FIGS. 3 and 4. The BSCDs of FIG. 5 are reconfigurable, by operation of the optical gates. Also provided in FIG. 5 is a sensing controller 100 connected to the optical gates of both BSCDs, so that the optical gates can be operated in a coordinated manner.

The protected infrastructure in the example of FIG. 5 is traversed by a bidirectional fiber cable. That is, transmissions enter and leave the protected infrastructure on a bidirectional fiber cable, as shown at the left and right sides of FIG. 5 by cable portions 40 and 40′. Within the infrastructure, between the BSCDs 30, 120, communication is on a pair of unidirectional fibers, i.e., on an upstream-directed fiber and a downstream-directed fiber. At each of the BSCDs, the interface between the unidirectional fibers on one side of the BSCD and the bidirectional fiber cable on the other side of the BSCD is implemented as described above in reference to FIGS. 3 and 4.

The embodiment of FIG. 5 can prevent unauthorized backscattering-based fiber sensing of the protected network infrastructure, without affecting sensing in the bidirectional fiber that lies outside the protected region. Backscattered light originated outside of the protected region would still propagate through the protected region, even when sensing is disabled within the protected region. However, backscattered light originated within the protected region would be blocked.

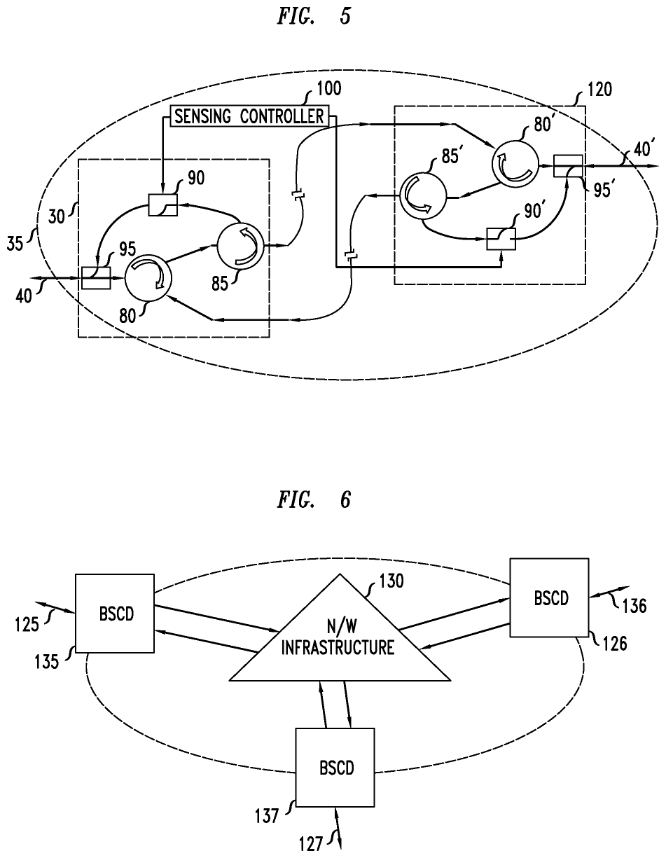

It can be the case, especially in large network premises or regions, that more than two bidirectional fiber cables converge on the protected infrastructure. In such a case, the BSCD system may comprise more than two individual BSCDs. For example, a respective BSCD may be placed at an edge of the protected region to interface with each of a multiplicity of bidirectional fiber cables that converge on the infrastructure. FIG. 6 schematically illustrates an example scenario in which three bidirectional fiber cables 125, 126, 127 converge on an infrastructure 130 protected by a system of three respective BSCDs 135, 136, 137.

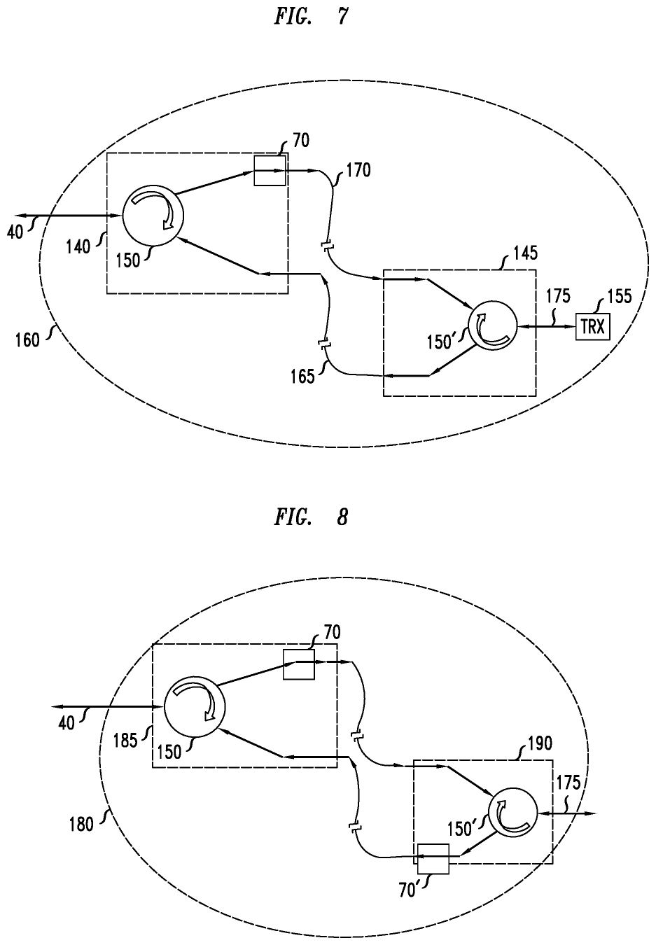

Example 4, non-reconfigurable endpoint protection, single transceiver port. FIG. 7 shows a non-reconfigurable BSCD system with a single transceiver (TRX) port, as is typical at the ONU side and the optical line terminal (OLT) side of current PON systems. As shown in the figure, a first BSCD 140 and a second BSCD 145 are used. Each BSCD includes a circulator 150, 150′ or similar element, having a bidirectional port, an upstream port, and a downstream port. The first BSCD 140 is placed at the edge location that meets the external bidirectional fiber 40. The second BSCD 145 is placed just before the transceiver 155 located in the protected infrastructure 160. The bidirectional port of the first BSCD 140 is connected to the external bidirectional fiber 40.

A pair of unidirectional fibers are deployed within the protected infrastructure. One fiber 165 of the pair is an upstream fiber, connected to the upstream ports of the two circulators. The other fiber 170 of the pair is a downstream fiber, connected to the downstream ports of the two circulators.

The first circulator 150 effectuates an interface between the unidirectional fiber pair 165, 170 and the fiber cable 40 shown at the left side of the figure, which may be, e.g., an optical access fiber to a private building or other private premises within a protected area. The second circulator 150′ effectuates an interface between the unidirectional fiber pair and a bidirectional fiber 175 that leads to the transceiver 155.

An optical isolator may be included in the first BSCD to block light backscattered from the downstream channel from returning in the upstream direction on the, e.g., access fiber.

Example 5, non-reconfigurable fiber segment protection. FIG. 8 is a schematic drawing showing, within a bidirectional fiber network, an example of non-reconfigurable BSCDs 185, 190 placed at the edges of an infrastructure 180 to protect the infrastructure.

The arrangement of FIG. 8 is similar to the arrangement of FIG. 7, except that the bidirectional port of the second circulator 150′ makes an interface to an intermediate part of the network, instead of to a network endpoint. Optical isolators 70, 70′ may be included in both BSCDs to block backscattered light. In each BSCD, the optical isolator is placed so as to block counterpropagating light that could otherwise return through the bidirectional port of the same BSCD. In implementations that use a quasi-circulator, the quasi-circulator may in at least some cases be effective for isolating the backscatter without the need to add an optical isolator.

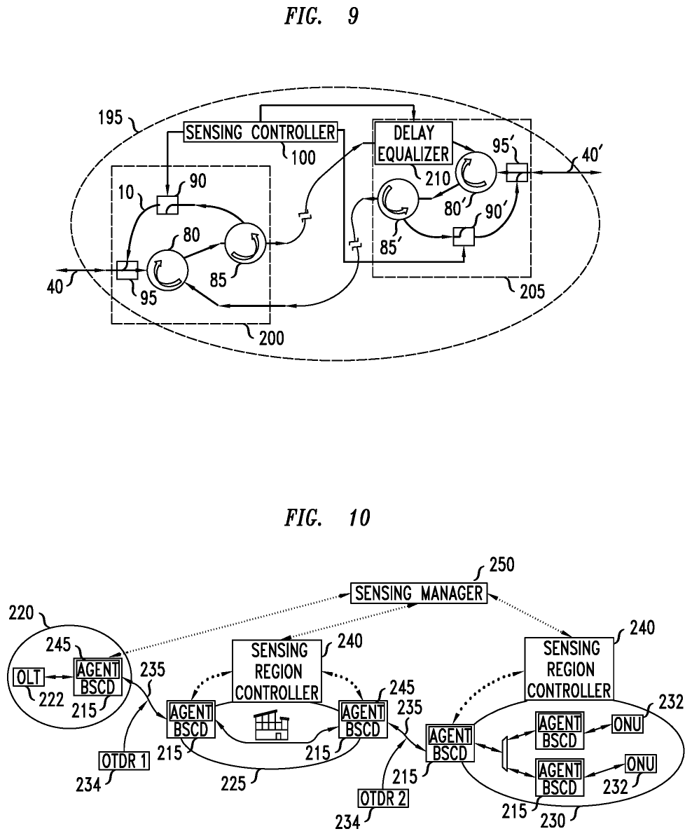

The BSCD for a protected network region may beneficially include a delay equalization device in cases, for example, where the two fibers of a unidirectional fiber pair have different lengths. One benefit of a delay equalization device is that it can facilitate symmetrical measurements from the respective sides of the protected infrastructure. FIG. 9 is a schematic drawing showing, within a network region 195 protected by a pair of BSCD elements 200, 205, an example of a delay equalization device 210 to account for propagation difference between the unidirectional fibers.

A protected network region may be provided with a sensing region controller that issues commands to the BSCDs across a given protected region. In embodiments, each BSCD is integrated with circuitry, referred to here as a “BSCD agent”, that interprets command signals received from the sensing region controller or other external authority, and responds by generating physical signals that cause the BSCD to behave in a specified manner such as opening or closing an optical gate.

A central sensing manager may be provided to exert control over the sensing region controllers, across multiple protected regions of the network.

An arbitrary number of BSCDs could be added across a large network. In embodiments, it would be possible, via communication between sensing region controllers and the BSCD agents they control, to individually control BSCDs to enable or disable fiber sensing in their respective protected regions. A central sensing manager could orchestrate the operation of BSCDs distributed across multiple protected regions.

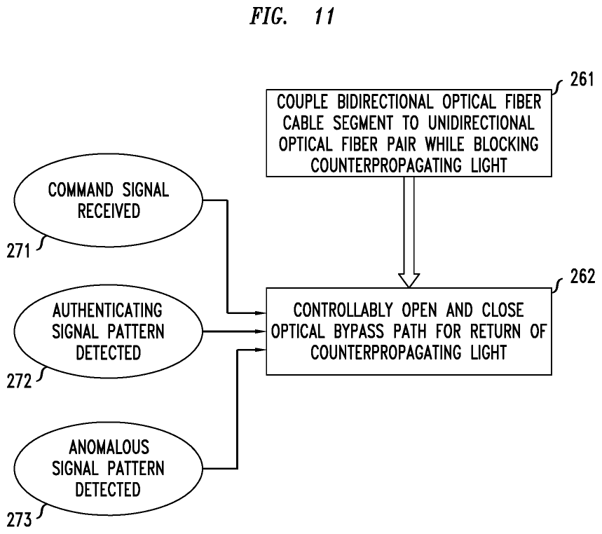

FIG. 10 shows an example of a network comprised of multiple sensing regions, each of which has a BSCD 215 as a demarcation element. As shown in the figure, the network includes operator premises 220, sensitive infrastructure premises 225, and customer premises 230, interconnected by optical fiber cable 235. Operator premises 220 may include, e.g., optical line termination (OLT) 222. Customer premises 230 may include, e.g., optical network units (ONUs) 232. Also shown in FIG. 10 are example authorized OTDR test devices 234.

It should be understood that FIG. 10 is intended only as an illustrative example.

In the example of FIG. 10, each sensing region may have a sensing region controller 240 that can enable and disable sensing within its local region by sending instructions to the BSCD agents in its region. Each BSCD 215 includes an integrated BSCD agent 245 able to translate the incoming control instructions from the local sensing region controller 240 into effective control of the BSCD by, e.g., changing the state of the optical gate to enable or disable the backscatter path.

In the example of FIG. 10, the sensing region controllers are controlled remotely by a central sensing manager 250. The central sensing manager may be configured to orchestrate sensing control over a large region encompassing multiple sensing regions. In various embodiments, communication signals between the sensing region controller and the BSCD agents could travel on dedicated sensing control and management channels, they could use the communication network control and management infrastructure, or they could travel on in-band communication channels.

In embodiments, a BSCD may include circuitry that enables it to independently control fiber sensing. For example, an optical splitter could divert a portion of the incoming light from a bidirectional fiber cable to a sensing circuit configured to recognize an optically transmitted authentication sequence known only to authorized operators of, e.g., OTDR test devices. An authentication sequence transmitted from the OTDR test device would, when recognized at the BSCD, cause the BSCD agent to permit fiber sensing.

In other examples, the BSCD circuitry may be configured to detect anomalous signal patterns, and to control fiber sensing in response to, e.g., a decision that the detected anomaly indicates a possible intrusion attempt.

For example, an optical splitter could divert a portion of the incoming light from a bidirectional fiber cable to a sensing circuit configured to monitor optical power. A sudden increase in optical power could be interpreted as an indication that fiber testing is being attempted, causing the BSCD agent to disable fiber testing.

In another example, by using wavelength-selective photodetection and power monitoring, it would be possible to selectively disable fiber sensing when a suspect OTDR pulse or the like is detected in an unauthorized OTDR wavelength channel. Alternatively, an optical spectrum analyzer (OSA) could be used to detect new wavelengths that are entering the system but are not part of the communication channel, thus indicating a possible intrusion.

FIG. 11 is a flowchart illustrating BSCD operation in example embodiments. At block 261, a bidirectional optical fiber cable segment is coupled to a unidirectional optical fiber pair, while blocking counterpropagating light. At block 262, an optical switch is controllable opened and closed to respectively admit and block the return of counterpropagating light on an optical bypass path. As indicated at block 271, the control of the optical switch may be responsive to received command signals. As indicated at block 272, the control of the optical switch may be responsive to detection of an authenticating signal pattern that signifies, e.g., a sensing attempt by an authorized party. As indicated at block 273, the control of the optical switch may be responsive to detection of an anomalous signal pattern that may be taken as an indication, e.g., of a sensing attempt by an unauthorized party.

We claim:

1. A system comprising at least a first network segment, wherein:
the system comprises at least a first bidirectional sensing control device (BSCD) situated at a first boundary of the first network segment;
the first network segment comprises a network infrastructure;
a pair of oppositely directed unidirectional optical fibers carry optical transmissions within the network infrastructure;
the first BSCD comprises a directionally selective optical coupling circuit configured as an interface between a first bidirectional optical fiber cable segment and the fiber pair, such that each fiber of the fiber pair is coupled to the first fiber cable segment for optical propagation in a respective propagation direction; and
the coupling circuit blocks counterpropagating light from returning from the network infrastructure to the first cable segment.

2. The system of claim 1, wherein the directionally selective optical coupling circuit comprises an optical circulator configured to couple downstream light from the first bidirectional fiber cable segment into one of the unidirectional fibers and to couple upstream light from the other of the unidirectional fibers into the first cable segment.

3. The system of claim 1, wherein:
the directionally selective optical coupling circuit comprises an optical circulator configured to couple downstream light from the first fiber cable segment into one of the unidirectional fibers and to couple upstream light from the other of the unidirectional fibers into the first fiber cable segment; and
the directionally selective optical coupling circuit further comprises an optical isolator configured to block counterpropagating light from returning from the network infrastructure to the first fiber cable segment.

4. The system of claim 1, wherein;
one of the unidirectional fibers is a downstream fiber for light propagating from the first fiber cable segment to the network infrastructure;
the first BSCD further comprises a bypass path for counterpropagating light going from the downstream fiber to the first fiber cable segment; and
the bypass path includes an optical gate to controllably allow and disallow entry of the counterpropagating light to the first fiber cable segment.

5. The system of claim 4, wherein the first BSCD further comprises a control circuit configured for activating and deactivating the optical gate.

6. The system of claim 5, wherein the control circuit is configured to detect a command signal transmitted on the first fiber cable segment, and to respond to the command signal by activating the optical gate to open or close.

7. The system of claim 5, wherein the control circuit is configured to detect a signal pattern transmitted on the first fiber cable segment that is indicative of an intrusion attempt, and to respond to the detected pattern by activating the optical gate to close.

8. The system of claim 1, wherein:
the system comprises two or more BSCDs, each of which is situated at a boundary of the first network segment;
each of the two or more BSCDs comprises a directionally selective optical coupling circuit configured as an interface between a respective bidirectional optical fiber cable segment and a respective pair of unidirectional optical fibers, such that each fiber of the respective fiber pair is coupled to the respective bidirectional optical fiber cable segment for optical propagation in a respective propagation direction;
the directionally selective optical coupling circuit of each of the two or more BSCDs is configured with an optical gate to controllably block counterpropagating light from returning from the network infrastructure to the respective cable segment connected to the BSCD; and
each of the two or more BSCDs further comprises a control circuit for causing the optical gate to open or close.

9. The system of claim 8, further comprising a sensing region controller configured to enable and disable sensing within the first network segment by sending instructions to the control circuit of each of the two or more BSCDs in the first network segment.

10. The system of claim 9, comprising two or more network segments, wherein:
at least one BSCD is situated at a boundary of each of the two or more network segments;
a respective sensing region controller for each of the two or more network segments is configured to enable and disable sensing within its own network segment by sending instructions to the control circuit of each of the two or more BSCDs within its own network segment; and
the system further comprises a central sensing manager configured to orchestrate sensing control across the two or more network segments by sending instructions to the respective sensing controller of each of the two or more network segments.

11. A method for controlling fiber sensing in a network segment that includes a network infrastructure that sends and receives transmissions on a bidirectional optical fiber cable segment, comprising:
at a boundary of the network segment, coupling optical transmissions between the bidirectional optical fiber cable segment and a pair of oppositely directed unidirectional optical fibers that carry optical transmissions within the network infrastructure, wherein:
the coupling is performed such that each fiber of the fiber pair is coupled to the first fiber cable segment for optical propagation in a respective propagation direction; and
the coupling is performed such that counterpropagating light is blocked from returning from the network infrastructure to the first fiber cable segment.

12. The method of claim 11, further comprising controllably opening and closing an optical bypass path that, when open, allows counterpropagating light to return from the network infrastructure to the first fiber cable segment.

13. The method of claim 12, wherein the controllably opening and closing an optical bypass path is performed in response to a command signal transmitted from a control unit.

14. The method of claim 12, wherein the controllably opening and closing an optical bypass path is performed in response to detecting an anomalous signal pattern transmitted on the bidirectional optical fiber cable segment.

15. The method of claim 12, wherein the controllably opening and closing an optical bypass path is performed in response to detecting a prespecified signal pattern transmitted from an authorized fiber sensing device on the bidirectional optical fiber cable segment.
